(19) United States
(12) Patent Application Publication
(10) Pub. No.: US 2026/0060862 A1
(43) Pub. Date: Mar. 5, 2026

(54) TROLLEY ATTACHMENT SYSTEMS FOR OVERHEAD LIFTS

(71) Applicant: Liko Research & Development AB, Luleå (SE)

(72) Inventors: Neal Wiggermann, Batesville, IN (US); Jacob J. Banks, Mason, OH (US); Robert Eneslätt, Luleå (SE)

(73) Assignee: Liko Research & Development AB, Luleå (SE)

(21) Appl. No.: 19/301,272

(22) Filed: Aug. 15, 2025

Related U.S. Application Data
(60) Provisional application No. 63/689,073, filed on Aug. 30, 2024.

(51) Int. Cl. A61G 7/10

(52) U.S. Cl. CPC A61G 7/1042; A61G 7/1015

(57) ABSTRACT

An overhead subject lift system is disclosed herein. The overhead subject lift system includes a track defined on an overhead surface, an overhead lift, and a trolley attachment slidably engaged with the track. The overhead lift includes a housing a strap extending out of the housing at an exit toward a ground surface. The exit is located a first distance from the overhead surface. The trolley attachment system includes a body, wherein the overhead lift is removably coupled to the body and redirecting members to redirect the strap extending out of the housing of the overhead lift at the exit toward a second point, wherein the second point extends a second distance from the overhead surface, and wherein the first distance is greater than the second distance.

### CROSS-REFERENCE TO RELATED APPLICATION

The present disclosure claims the priority benefit of U.S. Provisional Patent Application Ser. No. 63/689,073, entitled “TROLLEY ATTACHMENT SYSTEMS FOR OVERHEAD SUBJECT LIFTS” and filed Aug. 30, 2024, the entire contents of which is incorporated herein.

### BACKGROUND

### Field

The subject matter described herein relates to lifting devices for transporting and assisting subjects with compromised mobility, and more specifically, to components for attaching a trolley to an overhead rail.

### Technical Background

Overhead subject lift systems are used to lift and/or move a subject, such as a patient with limited mobility, from one location to another and/or from one position to another. More specifically, overhead subject lift systems can be used to mobilize a subject with a variety of applications in-bed, up-from-bed, and out-of-bed. Overhead subject lift systems can help improve subject outcomes-including fewer falls and/or shorter lengths of stay in a facility, for example.

As manual subject handling tasks are physically demanding on an operator, motorized subject lifts are an effective ergonomic intervention. However, utilization of such motorized subject lifts is often diminished due to inefficient functionality and/or availability. Such subject lifts commonly include a motorized overhead lift that is removably coupled to an overhead track by a trolley attachment system.

### SUMMARY

According to at least one aspect of the present disclosure, an overhead subject lift system is disclosed. The overhead subject lift system includes a track coupled to an overhead surface, an overhead lift, and a trolley attachment system slidably engaged with the track. The overhead lift includes a housing, a motor, and a strap extending out of the housing at an exit thereof toward a ground surface. The exit is located a first distance from the overhead surface. The trolley attachment includes a body, wherein the overhead lift is removably coupled, or otherwise moves adjacent, to the body, a first pulley to redirect the strap extending out of the housing of the overhead lift at the exit toward the track, and a second pulley to redirect the strap extending out of the first pulley toward the ground surface, wherein the second pulley extends a second distance from the overhead surface, wherein the first distance is greater than the second distance.

According to at least one aspect of the present disclosure, a trolley attachment system for slidable engagement with a track defined on a substantially planar overhead surface and removable attachment to an overhead lift having a strap extending away from the planar overhead surface at an exit thereof is disclosed. The trolley attachment system includes a body, a first pulley extending from the body to redirect the strap extending out of the overhead lift at the exit toward the track, and a second pulley extending from the body to redirect the strap extending out of the first pulley toward a ground surface, wherein the second pulley extends a second distance from the overhead surface, wherein the first distance is greater than the second distance.

According to at least one aspect of the present disclosure, an overhead subject lift system is disclosed. The overhead subject lift system includes a track coupled to an overhead surface, an overhead lift, and a trolley attachment slidably engaged with the track. The overhead lift includes a housing and a strap extending out of the housing at an exit thereof toward a ground surface. The trolley attachment system includes a body, wherein the overhead lift is removably coupled to the body, a first pulley positioned to redirect the strap in a direction substantially horizontal to the ground surface as the strap exits the housing of the overhead lift, a second pulley positioned to redirect the strap extending out of the first pulley in a direction toward the track; and a third pulley positioned to redirect the strap extending out of the second pulley in a direction toward the ground surface, wherein a first distance is defined between the exit of the overhead lift and a corresponding location on the track, wherein a second distance is defined between the third pulley and a corresponding location on the track, and wherein the first distance is greater than the second distance.

According to at least one aspect of the present disclosure, an overhead subject lift system is disclosed. The overhead subject lift system includes a track defined on an overhead surface, an overhead lift, and a trolley attachment slidably engaged with the track. The overhead lift includes a housing a strap extending out of the housing at an exit toward a ground surface. The exit is located a first distance from the overhead surface. The trolley attachment system includes a body, wherein the overhead lift is removably coupled to the body and redirecting members to redirect the strap extending out of the housing of the overhead lift at the exit toward a second point, wherein the second point extends a second distance from the overhead surface, and wherein the first distance is greater than the second distance.

### BRIEF DESCRIPTION OF THE DRAWINGS

The following detailed description of specific embodiments of the present disclosure can be best understood when read in conjunction with the following drawing, where like structure is indicated with like reference numerals and in which:

FIG. 1 depicts an overhead subject lift system having a conventional trolley attachment system and a track in accordance with at least one aspect of the present disclosure;

FIG. 2A depicts a partial end view of the track of the overhead subject lift system of FIG. 1;

FIG. 2B depicts a perspective view of the trolley of the overhead subject lift system of FIG. 1;

FIG. 3 depicts an overhead subject lift system having a trolley attachment system with one or more pulleys and a rail in accordance with at least one aspect of the present disclosure;

FIG. 4 depicts a trolley attachment system with one or more bumpers positioned adjacent a track in accordance with at least one aspect of the present disclosure;

FIG. 5 depicts an overhead subject lift system having a trolley attachment system with a body having one or more connecting members extending therebetween, the one or more connecting members including a resilient member in accordance with at least one aspect of the present disclosure; and

FIG. 6 depicts the overhead subject lift system having a trolley attachment system with a body having one or more connecting members extending therebetween, the one or more connecting members including an expanding member.

### DETAILED DESCRIPTION

Conventional trolley attachment systems used with overhead subject lift systems are bulky and/or are oriented in a manner that limits an ability for the overhead subject lift system to sufficiently lift a subject vertically. Such problems are exacerbated when the overhead subject lift system is installed, or otherwise used, in a space with relatively low ceiling heights, such as in an older medical facility and/or a subject's home, for example or in instances where the overhead subject lift system is being used with a subject of a particular height or to clear an object in the vertical direction. As such, the overhead subject lift system may have insufficient space in the vertical direction to lift a subject and the ability for the overhead subject lift system to impact, or otherwise improve, a subject's mobility is restricted and oftentimes results in the overhead subject lift system not being utilized.

Other characteristics of a space further restrict the use of conventional trolley attachment systems, such as size constraints in room dimensions and/or a ceiling geometry, for example. Furthermore, not all spaces where a subject needs assistance have suitable overhead surfaces, let alone overhead surfaces with a track defined thereon.

As used herein, words of approximation should be construed to mean “approximate,” rather than “perfect,” and may accordingly be employed as a meaningful modifier to any other word, specified parameter, quantity, quality, or concept. Words of approximation, include, but are not limited to, terms such as “substantial,” “nearly,” “almost,” “about,” “generally,” “largely,” “essentially,” “closely approximate,” etc. (including modifiers thereof). For example, the term “substantially planar” as used herein means that a surface (e.g., an overhead surface) lies in a plane and that some portions of the surface (e.g., less than about 20%, less than about 15%, less than about 10%, less than about 5%, less than about 4%, less than about 3%, less than about 2%, or less than about 1% of the surface) may lie outside of a plane. In addition, the term “substantially flat” as used herein means that a surface (e.g., an overhead surface) is flat and may include some imperfections and/or deviations. For example, a surface that is substantially flat may include bumps, texture, embossed indicia, divots, a slight bow, a slight curve, or the like (including combinations thereof).

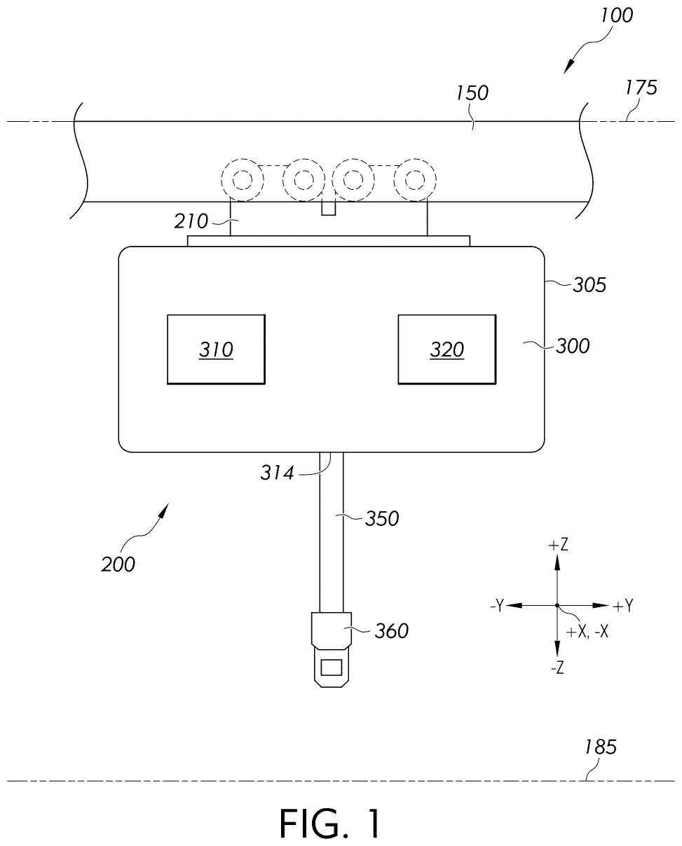

An overhead subject lift system 100 is depicted in FIG. 1. The overhead subject lift system 100 includes a track 150 (which may be referred to as a rail) and a conventional trolley attachment system 200. As discussed in greater detail herein, the track 150 (e.g., a rail) is coupled to, embedded within, or otherwise secured to an overhead surface such as a ceiling or a freestanding bar, for example.

While various trolley attachment systems are described herein, including conventional trolley attachment systems and improved trolley attachment systems, it is envisioned that any trolley attachment system can be used with the described track. Stated another way, use of the improved trolley attachment systems disclosed herein does not require any changes to be made to, and is otherwise compatible with, existing track.

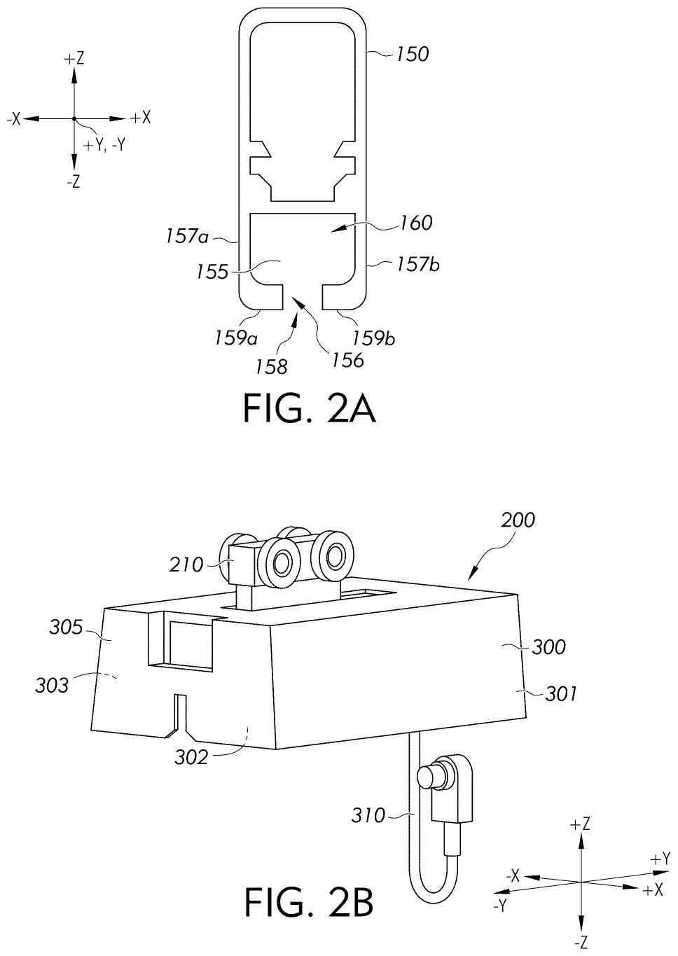

Trolley attachment systems include attachment features that are sized to be coupled to, or otherwise engaged with, the track of the overhead subject lift system. As shown in the illustrative partial end view of the track 150 in FIG. 2A, the track 150 has a channel 155 defined therein for receiving at least a portion of a trolley attachment system therein. As described in greater detail herein, in various instances, the trolley attachment system includes an attachment feature 210, such as one or more wheels, that allow, or otherwise facilitate, the trolley attachment system to be slidably and/or movably received in the channel 155 of the track 150. Such engagement between the trolley attachment system and the track allows the trolley attachment system to slide, roll, or otherwise move, along the track as a subject is being moved to a desired location.

An opening 160 can be defined at one or more ends of the track 150 to facilitate insertion of the attachment feature 210 therethrough. The opening 160 can be sized to closely receive the attachment feature 210 therethrough. Once the attachment feature 210 is received within the track 150, a cap can be coupled to the opening 160 to prevent the attachment feature 210 to disengage from the track 150 through the opening 160. In various instances, a stop feature can be defined within the channel 155 of the track 150 to prevent the attachment feature 210, and thus the trolley attachment system, from disengaging from the track 150 through the opening 160.

In various instances, the channel 155 can be defined by two sidewalls (e.g., a first sidewall 157a and a second sidewall 157b). The first sidewall 157a extends from a first base portion 159a, and the second sidewall 157b extends from a second base portion 159b. As shown in FIG. 2A, in various instances, while the first base portion 159a and the second base portion 159b extend toward one another, the first base portion 159a does not directly contact, or otherwise connect to, the second base portion 159b. Stated another way, the first base portion 159a and the second base portion 159b define a gap 156. The gap 156 is defined by a width that is less than a width between the first sidewall 157a and the second sidewall 157b. In such instances, the distance between the first base portion 159a and the second base portion 159b is small enough so as to prevent the attachment feature 210 of the trolley attachment system from falling through. In other instances, the first base portion 159a and the second base portion 159b directly contact one another to form a continuous, or otherwise solid, base 158.

The track 150 of the overhead subject lift system extends along an overhead surface 175, such as a ceiling or a freestanding bar, for example, so as to facilitate lifting and/or moving a subject from a current position to a desired position. In various instances, the track 150 can be fixedly mounted to the overhead surface 175, while in other instances, the track 150 can be removably coupled to the overhead surface 175. The track 150 can be coupled to the overhead surface 175 in any suitable manner, such as through brackets, screws, an adhesive, and/or the like. In various instances, the track 150 can be integrally-formed with the overhead surface 175.

In various instances, while not shown in the figures of the present application, the overhead surface 175 can be defined on a freestanding structure, such as a stand or a column, for example. The stand can include one or more support columns, or legs with the overhead surface extending therefrom. For example, the stand can include two support columns with the overhead surface 175 extending therebetween. The freestanding structure can be oriented, or otherwise positioned, around a chair, a bed, and/or any other structure from where a subject needs to be moved. In an effort to provide additional stability to the freestanding structure, for example, the one or more support columns can be fixed, or otherwise secured, to an adjacent surface, such as a floor and/or a wall, for example. In various instances, the one or more support columns can be weighted. In various instances, a height of the one or more support columns can be adjusted to accommodate moving and/or lifting a particular subject from a particular location.

In instances where the track 150 is coupled to the overhead surface 175 defined on the freestanding structure, the freestanding structure can be collapsible and/or movable between various locations based on a particular need for the device. For example, the freestanding structure can allow a facility, such as a hospital, nursing home, home of the subject, and/or the like, to readily utilize the overhead subject lift system for numerous subjects and/or in numerous different locations. The freestanding structure allows for the use of the overhead subject lift system in locations where a fixed overhead track is not present, or otherwise is not suitable for a desired use. In instances where the freestanding structure is collapsible, the freestanding structure can be compactly stored and/or transported.

In any event, the track 150 can be coupled in any suitable manner to any suitable overhead surface. In various instances, the overhead surface 175 is substantially flat and/or planar. It is envisioned that the track 150 extends a uniform distance from the overhead surface 175 along the length of the track 150. In various instances, the track 150 is straight, while in other instances, the track 150 is curved.

Based at least in part on a desired use of the subject lift system, in various instances, a length of the track 150 can be adjusted. Stated another way, the track 150 can be made longer or shorter so as to accommodate size constraints of an overhead surface 175 and/or movement of a subject from one location to another location, for example. In instances where only a portion of the track 150 is needed, the track 150 can be a telescopic track, for example. Such a telescopic track can include a first unused portion of the track selectively stored within a second used portion of the track in a shortened configuration. The first unused portion of the track can be extended out from within the second used portion of the track in a lengthened configuration.

The track 150 can be made of any suitable material that is rigid and strong enough to support the weight of a subject, such as a human being, for example. In various instances, the track 150 can be made of plastic, metal, and/or any suitable combination thereof.

A conventional trolley attachment system 200 is depicted in FIGS. 1 and 2B. As described above, the conventional trolley attachment system 200 includes one or more attachment features 210 for coupling the conventional trolley attachment system 200 to the track 150. The one or more attachment features 210 can include a wheel, a ball, or any suitably shaped feature that allows the conventional trolley attachment system 200 to selectively slide along the channel 155 of the track 150. The one or more attachment features 210 can be made out of any material suitable for facilitating a sliding translation of the conventional trolley attachment system 200 along the track 150. Stated another way, the one or more attachment features 210 are made of a material, or combination of materials, that has a low coefficient of friction. In various instances, a lubricant can be applied to the track 150 and/or the attachment features 210 to further facilitate the sliding translation of the conventional trolley attachment system 200 along the track 150.

An overhead lift 300 is coupled to, or otherwise supported on, the conventional trolley attachment system 200. The overhead lift 300 includes a housing 305, a power source 310, and a motor 320. The housing 305 is defined by a length 301, a width 302, and height 303. The overhead lift 300 is coupled to the conventional trolley attachment system 200 such that a length 301 of the overhead lift 300 extends in the same direction as the length of the track 150 in the −y and +y directions. The width 302 of the overhead lift 300 extends in a direction perpendicular to the length of the track 150 in the −x and +x directions. The motor is positioned within the housing. In various instances, the power source includes a rechargeable battery housed entirely within the overhead lift 300 so as to be untethered to any remote structure. In various instances, the power source includes an electrical plug to be inserted into an outlet or receptacle to establish an electrical connection between the overhead lift 300 and a remote power supply.

The overhead lift 300 further includes a strap 350 and, in various instances, a buckle 360 coupled to the strap 350 for engagement with a lift hanger, a sling, and/or a subject, for example. In various instances, the buckle 360 is coupled to an end of the strap 350. The buckle 360 can include one component of a buckle system, such as a plug or a receptacle, for example. A lift hanger and/or a sling supporting a subject therein can include the corresponding component of the buckle system. In other instances, an alternate component can be coupled to the strap 350, such as a slingbar, for example. In other instances, nothing is coupled to the strap 350. In various instances, the strap 350 is a flexible strap akin to a seat belt, for example. As depicted in FIG. 1, when used with the conventional trolley attachment system 200, the strap 350, including a buckle 360 (e.g., an optional buckle), extends downward out of an exit 314 in the overhead lift toward a ground surface 185 in the −z direction from the overhead lift 300. Such extension in the −z direction limits, or otherwise restricts, a height to which a subject can be lifted. As described above, various buildings, such as older hospitals and/or homes, for example, have limited ceiling heights. In such instances, use of the conventional trolley attachment system 200 can prevent a subject from being lifted and/or moved to a desired location and/or position. Additionally and/or alternatively, a height of a subject can restrict an ability for the overhead lift 300 to move and/or lift the particular subject to a desired location and/or position.

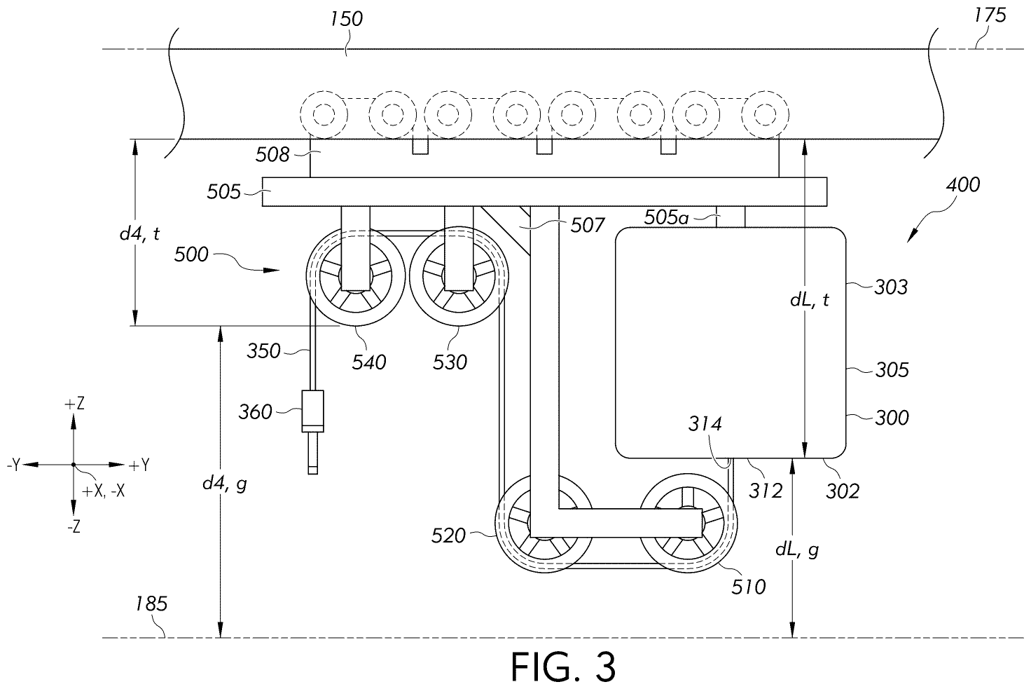

FIG. 3 depicts an overhead subject lift system 400 including the track 150 and a trolley attachment system 500. The trolley attachment system 500 includes a body 505. The body 505 can be in the form of a bar, for example. In various instances, the body 505 is hollow. In other instances, the body 505 is solid. The body 505 is made of any suitable material to support the weight of the overhead lift 300 and a subject, such as human being, hanging therefrom. The body 505 can be made from plastic, metal, and/or the like. Based at least in part on a particular use of the trolley attachment system 500 and/or a particular subject to be lifted by the trolley attachment system 500, characteristics of the body 505 can be altered. As described in greater detail below, the trolley attachment system 500 includes various features coupled thereto including an overhead lift 300, one or more attachment features, and/or one or more redirecting features. A length of the body 505 of the trolley attachment system 500 can be optimized and/or dictated based at least in part on a number of components coupled thereto. Stated another way, a body 505 having fewer components coupled thereto can be defined by a length that is less than a length of a body 505 having more components coupled thereto. In various instances, the body 505 can take the form of a bar. In various instances, one or more branches can extend from the bar to support components thereon at different vertical positions, for example. In various instances, the body 505 can include one or more support trusses 507 coupled thereto to prevent flexing of the body 505. In various instances, the one or more support trusses can be welded and/or screwed to the body 505, for example. The one or more support trusses can be removably coupled to the body 505 such that the one or more support trusses can be selectively coupled to the body 505 to provide additional support in a particular location based at least in part on the particular subject to be lifted and/or moved by the overhead subject lift system and/or the particular location in which the overhead subject lift system is being operated.

Similar to the conventional trolley attachment system 200, the trolley attachment system 500 is removably coupled to the track 150. As such, the trolley attachment system 500 is detachable from the track 150 in a first location and coupled to a track 150 in a second location, for example. The trolley attachment system 500 includes one or more attachment features 508, such as one or more wheels and/or other rotatable bodies, for example, extending from the body 505 to engage with the channel 155 of the track 150. The one or more attachment features 508 facilitate a sliding translation of the trolley attachment system 500 along a length of the track 150.

The overhead lift 300, including the housing 305, the power source 310, the motor 320, the strap 350, and the buckle 360, is coupled to a first portion 505a of the body 505. More specifically, the housing 305 is coupled to the first portion 505a of the body 505. The overhead lift 300 is coupled to the body 505 in an orientation such that the width 302 of the overhead lift 300 extends generally in the same direction as the length of the track 150 in the −y and +y directions while the length 301 of the overhead lift 300 extends substantially perpendicular to the length of the track 150 in the −x and +x directions. Stated another way, the overhead lift 300 is coupled to the body 505 of the trolley attachment system 500 in an orientation that is rotated substantially 90 degrees about a vertical axis from the orientation the overhead lift 300 is coupled to the conventional trolley attachment system 200 shown in FIG. 1. In various instances, the overhead lift 300 is screwed, or otherwise secured, to the trolley attachment system 500 using a bracket system, for example.

A plurality of redirecting members 510, 520, 530, 540 are selectively coupled, or otherwise connected, to the body 505 of the trolley attachment system 500. The redirecting members can include pulleys, guides, rollers, channels, skids, wheels, curved edges, fixed slots, and/or any suitable surface or mechanism to facilitate redirecting the strap 350 in a particular, desired direction. As depicted in FIG. 3, the redirecting members 510, 520, 530, 540 are illustrated as pulleys. The redirecting members 510, 520, 530, 540 are coupled, or otherwise connected, to the body 505 of the trolley attachment system 500 in any suitable manner. In various instances, the redirecting members 510, 520, 530, 540 are integrally formed with the body 505 of the trolley attachment system 500. In other instances, the redirecting members 510, 520, 530, 540 are selectively mounted along a length and/or height of the body 505 based at least in part use of the trolley attachment system 500 with a particular subject and/or for a particular movement. For example, a user can adjust a number and/or a location of redirecting members for use with the trolley attachment system 500. The user can selectively adjust the redirecting members based on limitations in a given room, or space, in which the trolley attachment system 500 is being used and/or based on characteristics of a particular subject to be lifted, such as a height and/or a weight of the subject, for example. The redirecting members 510, 520, 530, 540 can be mounted to the body 505 by way of screws, brackets, and/or adhesives, for example. In various instances, the redirecting members 510, 520, 530, 540 can be slidably adjusted along a length of the body 505, such as through a channel defined within the body 505, for example, In such instances, the redirecting members 510, 520, 530, 540 can include locking mechanisms to secure the redirecting members 510, 520, 530, 540 in a desired position. In various instances, the locking mechanisms can include a braking system and/or a pin and hole system, for example. The redirecting members 510, 520, 530, 540 are sized so as to readily facilitate the strap 350 and any corresponding accessory, such as the buckle 360, to be redirected therethrough. Stated another way, a width of the redirecting members 510, 520, 530, 540 is equivalent to or is greater than a width of the strap 350. As such, the strap 350 is able to rest flat against the redirecting members 510, 520, 530, 540 without folding, or otherwise twisting, for example. Furthermore, the width of the redirecting members 510, 520, 530, 540 is such that prevents the strap 350 from detaching from the redirecting members 510, 520, 530, 540 and/or become tangled as the strap 350 is extended or retracted from the overhead lift 300. The redirecting members 510, 520, 530, 540 allow the strap 350 to exit and pull perpendicular to the overhead lift 300. In various instances, the redirecting members 510, 520, 530, 540 can define a slot through a body of the redirecting members 510, 520, 530, 540 to receive the strap 350 therethrough. Such a slot can be sized such as to receive the strap 350 therethough in a flat orientation.

As depicted in FIG. 3, a first redirecting member 510 is coupled to the body 505 at a location adjacent a base 312 of the overhead lift 300. In various instances, the first redirecting member 510 is laterally aligned with, the base 312 of the overhead lift 300. In other instances, the first redirecting member 510 is laterally offset from the base 312 of the overhead lift 300. In any event, the first redirecting member 510 extends from the body 505 at a position further away from the overhead surface 175 than the base 312 of the overhead lift 300. Such vertical positioning allows for the first redirecting member 510 to engage the strap 350 as it extends out of the overhead lift 300 and maintain the strap 350 in a vertical position as it exits the overhead lift 300.

A second redirecting member 520 is coupled to the body 505 of the trolley attachment system 500 adjacent the first redirecting member 510. The second redirecting member 520 is laterally offset from the first redirecting member 510. In various instances, as depicted in FIG. 3, the second redirecting member 520 is vertically aligned with the first redirecting member 510. Stated another way, the first redirecting member 510 and the second redirecting member 520 extend the same distance from the track 150. In other instances, the second redirecting member 520 can be vertically offset from the first redirecting member 510. In such instances, the second redirecting member 520 can be positioned closer to the track 150 or further away from the track 150 than the first redirecting member 510.

A third redirecting member 530 is coupled to the body 505 of the trolley attachment system 500 adjacent the second redirecting member 520. As shown in FIG. 3, the second redirecting member 520 is coupled to the body 505 at a lateral position between the first redirecting member 510 and the third redirecting member 530. The third redirecting member 530 is laterally offset from the first redirecting member 510 and the second redirecting member 520. As depicted in FIG. 3, the third redirecting member 530 is vertically offset from the second redirecting member 520 and the first redirecting member 510. The third redirecting member 530 is positioned closer to the track 150 than the first redirecting member 510 and the second redirecting member 520.

A fourth redirecting member 540 is coupled to the body 505 of the trolley attachment system 500 adjacent the third redirecting member 530. As shown in FIG. 3, the third redirecting member 530 is coupled to the body 505 at a lateral position between the second redirecting member 520 and the fourth redirecting member 540. The fourth redirecting member 540 is laterally offset from the first redirecting member 510, the second redirecting member 520, and the third redirecting member 530. As depicted in FIG. 3, the fourth redirecting member 540 is vertically aligned with the third redirecting member 530. In other instances, the fourth redirecting member 540 can be vertically offset from the third redirecting member 530. In such instances, the fourth redirecting member 540 can be positioned closer to the track 150 or further away from the track than the third redirecting member 530.

The strap 350 initially extends downward out of the exit 314 of the overhead lift 300 toward a ground surface 185 in the −z direction from the overhead lift 300; however, the strap 350 is engaged by the first redirecting member 510 extending from the body 505 to redirect the strap 350 in the −y direction. In an effort to maximize a distance between the ground surface 185 and the overhead subject lift system 400, the first redirecting member 510 engages the strap 350 at a location substantially adjacent the exit 314 of the overhead lift 300. The strap 350 continues extending in the −y direction until the second redirecting member 520 redirects the strap 350 in the +z direction. Stated another way, the second redirecting member 520 redirects the strap in an upward direction toward the track 150. The strap 350 continues extending in the +z direction until the third redirecting member 530 redirects the strap 350 in the −y direction. The strap 350 continues extending in the −y direction until the fourth redirecting member 540 redirects the strap 350 in the −z direction. Stated another way, the fourth redirecting member 540 redirects the strap 350 in a downward direction toward the ground surface 185. In instances where a ground surface 185 is substantially planar, or flat, along the length of the trolley attachment system 500, a distance d_{4.g} between the fourth redirecting member 540 and the ground surface 185 is greater than a distance d_{L.g} between the exit 314 of the overhead lift 300 and a corresponding location of the ground surface 185. As a result, the trolley attachment system 500 allows increased height for a subject to be lifted and/or moved by the overhead subject lift system 400. As described above, a portion of the ground surface 185 extending beneath the trolley attachment system 500 is substantially flat and/or planar. In instances where the ground surface 185 includes a hill or a stepped surface, for example, the distance d_{4.g} may not be greater than the distance d_{L.g}.

Stated another way, a distance d_{L,t} is defined between the exit 314 on the overhead lift 300 and a corresponding location on the track 150. Such a corresponding location is a point directly vertical from the exit 314, for example. A distance d_{4,t} is defined between the fourth redirecting member 540 and a corresponding location on the track 150. Such a corresponding location is a point directly vertical from the fourth redirecting member 540, for example. The distance d_{4,t} is less than the distance d_{L,t} such that the trolley attachment system 500 allows increased height for a subject to be lifted and/or moved by the overhead subject lift system 400. As described herein, the track 150 extends along an overhead surface 175 (e.g, a substantially planar overhead surface). Similar to the ground surface 185 described above, a portion of the overhead surface 175 extending above the trolley attachment system 500 is substantially planar and/or flat. In instances where the overhead surface 175 is sloped or stepped, for example, the distance d_{4,t} may not be less than the distance d_{L,t}.

While the trolley attachment system 500 is described as having four redirecting members 510, 520, 530, 540 extending from the body 505, various instances are envisioned where more redirecting members are utilized and where less redirecting members are utilized. For example, the third redirecting member 530 can be eliminated, leaving a trolley attachment system 500 with three redirecting members 510, 520, 540. In such instances, the fourth redirecting member 540 can be used to redirect the strap 350 from an upward +z direction toward a downward −z direction, for example. Additionally, the second redirecting member 520 can be eliminated in some instances, leaving a trolley attachment system 500 with two redirecting members 510, 540. In such instances, the first redirecting member 510 can be used to redirect the strap 350 from a downward −z direction toward an upward +z direction and the fourth redirecting member 540 can be used to redirect the strap from the upward +z direction toward the downward −z direction, for example.

More redirecting members can be added to the trolley attachment system 500, such as between the second redirecting member 520 and the third redirecting member 530, for example. A suitable number of redirecting members is provided so as to have a spacing between each adjacent redirecting member that prevents the strap 350 from becoming twisted, for example. Stated another way, as a distance between adjacent redirecting members increase, the strap 350 extending therebetween is more susceptible to twisting, such as when there is slack in the strap 350, for example. Minimizing the distance between adjacent redirecting members minimizes the risk of the strap 350 becoming twisted. In instances where the strap 350 becomes twisted, an ability for the overhead lift system to transport a subject thereon is significantly hampered and in various instances, causes the motor 320 of the overhead lift 300 to shut off, for example.

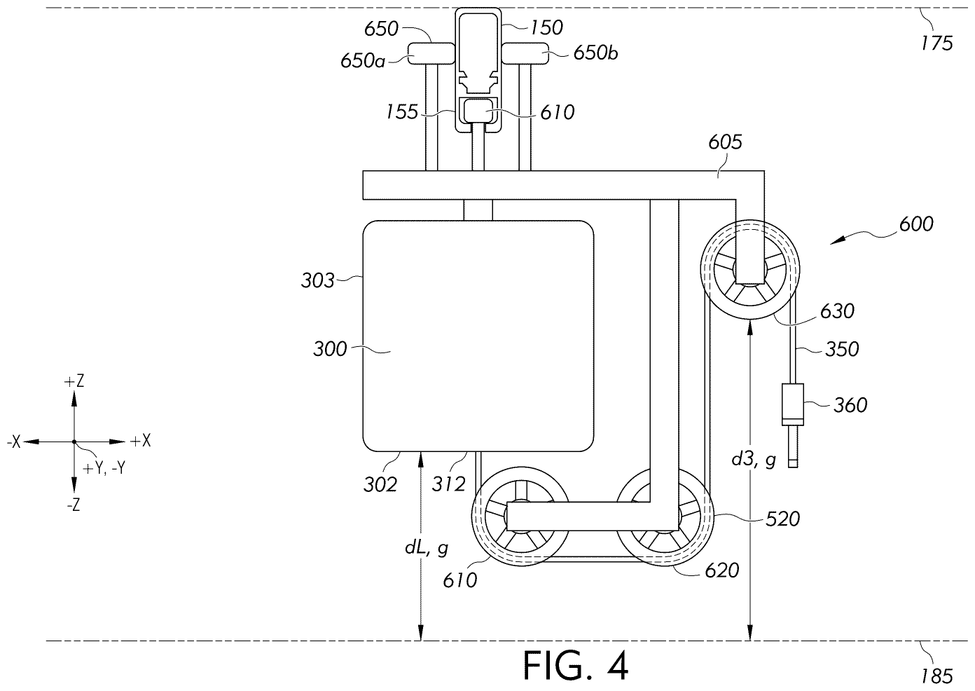

As the components of the overhead lift systems described herein are subject to significant forces due, at least in part, to the weight of the subject the overhead lift system is supporting, various components, such as the track 150 and/or the body 505 of the trolley attachment system 500, may experience a torque that can result in twisting, or an otherwise off-centering displacement. Turning now to FIG. 4, a cross-sectional representation of a trolley attachment system 600 is depicted. Similar in many respects to the trolley attachment system 500 depicted in FIG. 3, the trolley attachment system 600 depicted in FIG. 4 is removably coupled to the track 150 by way of one or more attachment features, similar in many respects to the attachment features 508. Thus, for the purposes of brevity, the particular details of such features will not be repeated herein.

The overhead lift 300, including the housing 305, the power source 310, the motor 320, the strap 350, and any corresponding accessory, such as the buckle 360, is coupled to the body 605. More specifically, the housing 305 is coupled to the body 605. The overhead lift 300 is coupled to the body 605 in an orientation such that the length 301 of the overhead lift 300 extends in the same direction as the length of the track 150 in the −y and +y directions while the width 302 of the overhead lift 300 extends substantially perpendicular to the length of the track 150 in the −x and +x directions. Stated another way, the overhead lift 300 is coupled to the body 605 of the trolley attachment system 600 in an orientation that is rotated substantially 90 degrees about a vertical axis from the orientation the overhead lift 300 is coupled to the trolley attachment system 500. The overhead lift 300 is coupled to the body 605 in an orientation substantially the same as the orientation the overhead lift 300 is coupled to the conventional trolley attachment system 200.

A plurality of redirecting members (e.g., the first redirecting member 610, the second redirecting member 620, and the third redirecting member 630) are coupled, or otherwise connected, to the body 605 of the trolley attachment system 600. The plurality of redirecting members (e.g., the first redirecting member 610, the second redirecting member 620, and the third redirecting member 630) are similar in many respects to the redirecting members 510, 520, 530, 540. The plurality of redirecting members (e.g., the first redirecting member 610, the second redirecting member 620, and the third redirecting member 630) are illustrated in FIG. 4 as pulleys; however, any suitable redirecting member or combination thereof can be used.

As depicted in FIG. 4, a first redirecting member 610 is coupled to the body 605 at a location adjacent a base 312 of the overhead lift 300. In various instances, the first redirecting member 610 is laterally aligned with the base 312 of the overhead lift 300. In other instances, the first redirecting member 610 is laterally offset from the base 312 of the overhead lift 300. In any event, the first redirecting member 610 extends from the body 605 at a position further away from the overhead surface 175 than the base 312 of the overhead lift 300. Such vertical positioning allows for the first redirecting member 610 to engage the strap 350 as it extends out of the overhead lift 300.

A second redirecting member 620 is coupled to the body 605 of the trolley attachment system 600 adjacent the first redirecting member 610. The second redirecting member 620 is laterally offset from the first redirecting member 610. In various instances, as depicted in FIG. 4, the second redirecting member 620 is vertically aligned with the first redirecting member 610. Stated another way, the first redirecting member 610 and the second redirecting member 620 extend the same distance from the track 150 and/or the overhead surface 175. In other instances, the second redirecting member 620 can be vertically offset from the first redirecting member 610. In such instances, the second redirecting member 620 can be positioned closer to the track 150 or further away from the track 150 than the first redirecting member 610.

A third redirecting member 630 is coupled to the body 605 of the trolley attachment system 600 adjacent the second redirecting member 620. As shown in FIG. 4, the second redirecting member 620 is coupled to the body 605 at a lateral position between the first redirecting member 610 and the third redirecting member 630. The third redirecting member 630 is laterally offset from the first redirecting member 610 and the second redirecting member 620. As depicted in FIG. 4, the third redirecting member 630 is vertically offset from the second redirecting member 620 and the first redirecting member 610. The third redirecting member 630 is positioned closer to the track 150 and/or the overhead surface 175 than the first redirecting member 610 and the second redirecting member 620.

The strap 350 begins to extend downward toward the ground surface 185 in the −z direction from the overhead lift 300; however, the strap 350 is engaged by the first redirecting member 610 extending from the body 605 to redirect the strap 350 in the +x direction. In an effort to maximize a distance between the ground surface and the trolley attachment system 500, the first redirecting member 610 engages the strap 350 at a location substantially adjacent the exit 314 of the overhead lift 300. The strap 350 continues extending in the +x direction until the second redirecting member 620 extending from the body 605 redirects the strap 350 in the +z direction. Stated another way, the second redirecting member 620 redirects the strap 350 in an upward direction toward the track 150. The strap 350 continues extending in the +2 direction until the third redirecting member 630 extending from the body 605 redirects the strap 350 in the −z direction. Stated another way, the third redirecting member 630 redirects the strap 350 in a downward direction toward the ground surface 185. A distance d_{3.g} the third redirecting member 630 and the ground surface 185 is greater than a distance dig between the exit 314 of the overhead lift 300 and a corresponding location on the ground surface 185. As a result, the trolley attachment system 600 allows increased height for a subject to be lifted and/or moved by the overhead subject lift system.

The trolley attachment system 600 further includes one or more bumpers 650 extending from the body 605 toward the track 150. The one or more bumpers 650 shown in FIG. 4 include a first bumper portion 650a and a second bumper portion 650b. The first bumper portion 650a extends adjacent the track 150 on a first side, while the second bumper portion 650b extends adjacent the track on a second side. In various instances, the one or more bumper 650 can only be positioned on one side of the track. In various instances, the one or more bumpers 650 can extend along substantially an entire length of the trolley attachment system 600. In such instances, one bumper 650 can extend along substantially the entire length of the trolley attachment system 600 for positioning adjacent the first side of the track 150 and/or one bumper 650 can extend along substantially the entire length of the trolley attachment system 600 for positioning adjacent the second side of the track 150. In other instances, multiple, separate and distinct bumpers 650 can extend along substantially the entire length of the trolley attachment system 600.

In various instances, the one or more bumpers 650 include projections and/or blocks extending from the body 605 that are made of a durable material, such as metal and/or rubber, for example. As such, in response to forces from lifting and/or moving a subject, the one or more bumpers 650 can bounce off of the track 150, or otherwise resist an off-centering movement between the trolley attachment system 600 and the track 150 to maintain the trolley attachment system 600 in an upright, or otherwise desirable, orientation. In other instances, the one or more bumpers 650 include wheels to maintain a desired orientation of the trolley attachment system 600 relative to the track 150.

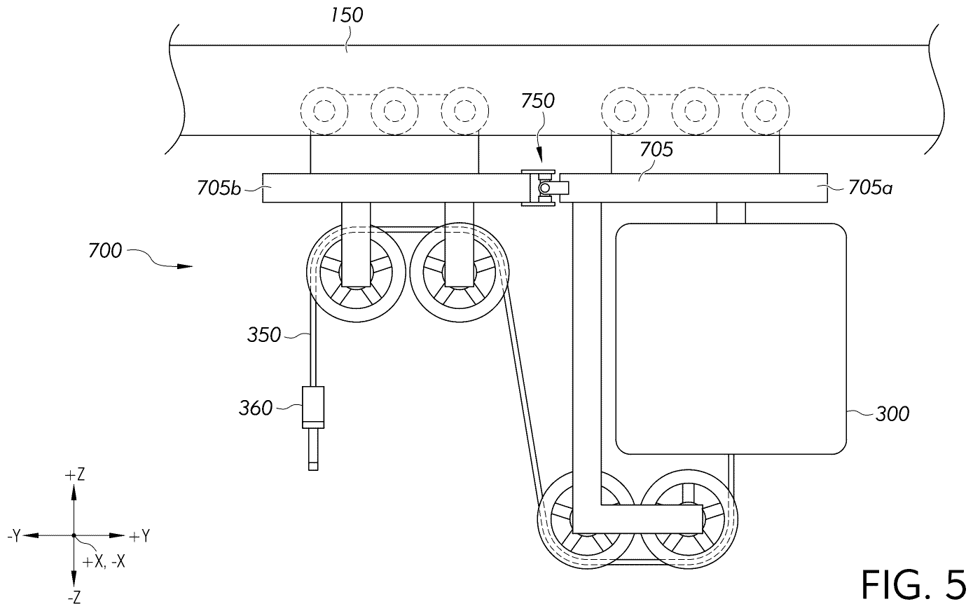

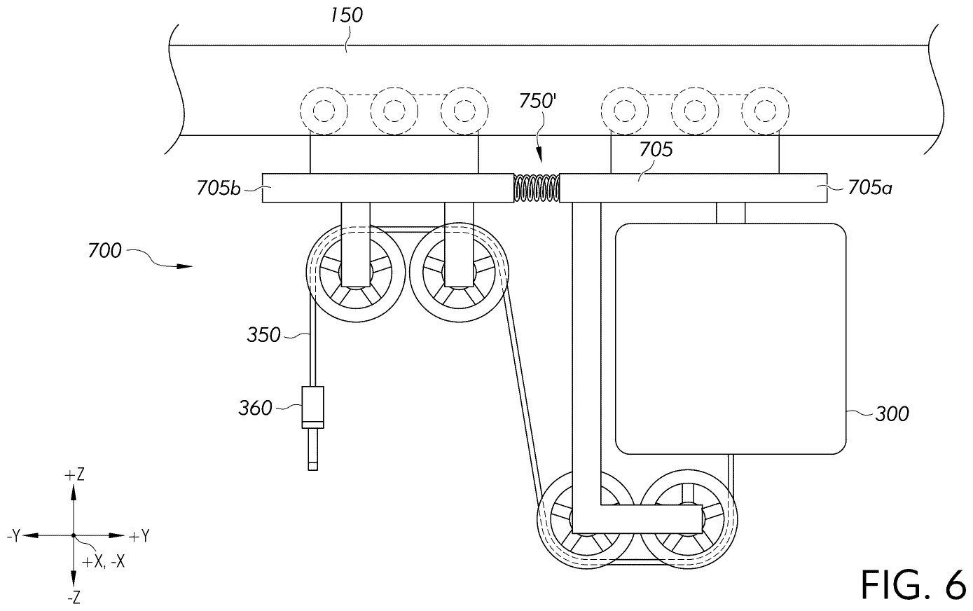

As discussed herein, the trolley attachment systems described herein are able to be used with various types of rails, including curved rails, for example. In an effort to case, or otherwise facilitate, translation of the trolley attachment systems along a curved length of a curved rail, for example, one or more connecting members 750 can be incorporated into a body of a trolley attachment system 700, as shown in FIGS. 5 and 6. The trolley attachment system 700 is similar in many respects to the trolley attachment system 500. The trolley attachment system 700 includes a body 705 similar to the body 505. The body 705 includes a first portion 705a and a second portion 705b. The one or more connecting members 750 allow for the first portion 705a and the second portion 705b to readily traverse a curved bar as the first portion 705a and the second portion 705b sequentially encounter a curve thereof. Stated another way, the connecting member 750 allows for the first portion 705a to move relative to the second portion 705b without twisting the body 705 and/or disrupting the structural integrity of the body 705. In various instances, more than one connecting member 750 can be incorporated into the body 705 to separate numerous portions thereof. For example, as a length of the body 705 increases, more connecting members 750 may be desired.

As shown in FIG. 5, the one or more connecting members 750 includes an expanding member, such as a hinge, for example. In various instances, the one or more connecting members 750 can be any suitable combination of expanding members and/or resilient members, for example. The one or more hinges can be opened manually to define a gap between the first portion 705a and the second portion 705b of the body 705. The definition of the gap allows for the first portion 705a of the body 705 to flex, or otherwise move, with respect to the second portion 705b of the body 705. In such instances, the body 705 acts as a resilient member. In various instances, the hinges can be automatically opened, or otherwise opened without manual intervention, in response to a sufficient force encountered as the trolley attachment system 700 translates along a curved track, for example. Stated another way, a hinge can be popped, or otherwise forced, open as the first portion 705a of the body 705 begins traversing a curve. The one or more hinges can transition between an open position and a closed position based on a particular use and/or attachment to a particular track, for example. In instances where the track is curved, for example, the one or more hinges may be placed in the open position.

As shown in FIG. 6, the one or more connecting members 750 includes a resilient member 750′ extending between the first portion 705a and the second portion 705b effectively coupling the first portion 705a and the second portion 705b to one another. In various instances, the resilient member 750′ includes a spring, for example. As the first portion 705a encounters a curved portion of a curved bar, the resilient member 750′ can expand to allow for the first portion 705a of the body 705 to flex, or otherwise rotate, with respect to the second portion 705b of the body 705. The resilient member 750′ can compress as needed to allow desirable flexion between the first portion 705a and the second portion 705b, such as then the curved bar begins to straighten, a degree of curvature changes, and/or a direction of curvature changes, for example.

Further aspects of the embodiments described herein are provided by the subject matter of the following clauses:

An overhead subject lift system is disclosed. The overhead subject lift system includes a track coupled to an overhead surface, an overhead lift including a housing, a motor, and a strap extending out of the housing at an exit thereof toward a ground surface, wherein the exit is located a first distance from the overhead surface, and a trolley attachment system slidably engaged with the track. The trolley attachment system includes a body, wherein the overhead lift is removably coupled to the body, a first pulley to redirect the strap extending out of the housing of the overhead lift at the exit toward the track, and a second pulley to redirect the strap extending out of the first pulley toward the ground surface, wherein the second pulley extends a second distance from the overhead surface, wherein the first distance is greater than the second distance.

The overhead subject lift system according to any of the preceding clauses, wherein the overhead surface is substantially planar.

The overhead subject lift system according to any of the preceding clauses, wherein a third distance is defined between the exit of the overhead lift and a location on the ground surface positioned directly under the exit, wherein a fourth distance is defined between the second pulley and a location on the ground surface positioned directly under the second pulley, and wherein the fourth distance is greater than the third distance.

The overhead subject lift system according to any of the preceding clauses, wherein the ground surface is substantially planar.

The overhead subject lift system according to any of the preceding clauses, wherein the trolley attachment system further includes one or more attachment features for removably coupling the trolley attachment system to the track.

The overhead subject lift system according to any of the preceding clauses, wherein the one or more attachment features includes a wheel.

The overhead subject lift system according to any of the preceding clauses, wherein the body of the trolley attachment system includes a first portion and a second portion, and wherein a resilient member couples the first portion to the second portion such that the first portion can move relative to the second portion.

The overhead subject lift system according to any of the preceding clauses, wherein the resilient member includes a spring.

The overhead subject lift system according to any of the preceding clauses, wherein the track defines a channel therein, and wherein the channel is sized to slidably receive at least a portion of the trolley attachment feature therein.

The overhead subject lift system according to any of the preceding clauses, wherein the trolley attachment system further includes one or more bumpers extending from the body toward the track when the trolley attachment system is coupled to the track.

The overhead subject lift system according to any of the preceding clauses, wherein the one or more bumpers include a first bumper portion positioned adjacent a first side of the track and a second bumper portion positioned adjacent a second side of the track.

The overhead subject lift system of any of claims 10 and 11, wherein the one or more bumpers include a wheel.

A trolley attachment system for slidable engagement with a track defined on a substantially planar overhead surface and removable attachment to an overhead lift having a strap extending away from the planar overhead surface at an exit thereof is disclosed. The trolley attachment system includes a body, a first pulley extending from the body to redirect the strap extending out of the overhead lift at the exit toward the track, and a second pulley extending from the body to redirect the strap extending out of the first pulley toward a ground surface, wherein the second pulley extends a second distance from the overhead surface, wherein the first distance is greater than the second distance.

The trolley attachment system of according to any of the preceding clauses, further comprising a third pulley positioned in between the first pulley and the second pulley to redirect the strap extending out of the first pulley in a direction substantially horizontal to the ground surface, and wherein the second pulley redirects the strap extending out of the third pulley toward the ground surface.

The trolley attachment system according to any of the preceding clauses, wherein the trolley attachment system further includes one or more attachment features for removably coupling the trolley attachment system to the track.

The trolley attachment system according to any of the preceding clauses, wherein the one or more attachment features includes a wheel.

The trolley attachment system according to any of the preceding clauses, wherein the body of the trolley attachment system includes a first portion and a second portion, and wherein a resilient member couples the first portion to the second portion such that the first portion can move relative to the second portion.

The trolley attachment system according to any of the preceding clauses, wherein the resilient member includes a spring.

The trolley attachment system according to any of the preceding clauses, wherein the body of the trolley attachment system includes a first portion and a second portion, and wherein an expanding member couples the first portion to the second portion such that the first portion can flex relative to the second portion.

The trolley attachment system according to any of the preceding clauses, wherein the expanding member includes a hinge.

The trolley attachment system according to any of the preceding clauses, wherein the hinge is in an open position when the trolley attachment system is coupled to a curved track.

An overhead subject lift system is disclosed. The overhead subject lift system includes a track coupled to an overhead surface, an overhead lift including a housing, and a strap extending out of the housing at an exit thereof toward a ground surface, and a trolley attachment system slidably engaged with the track. The trolley attachment system includes a body, wherein the overhead lift is removably coupled to the body, a first pulley positioned to redirect the strap in a direction substantially horizontal to the ground surface as the strap exits the housing of the overhead lift, a second pulley positioned to redirect the strap extending out of the first pulley in a direction toward the track, and a third pulley positioned to redirect the strap extending out of the second pulley in a direction toward the ground surface, wherein a first distance is defined between the exit of the overhead lift and a corresponding location on the track, wherein a second distance is defined between the third pulley and a corresponding location on the track, and wherein the first distance is greater than the second distance.

The overhead subject lift system according to any of the preceding clauses, wherein the trolley attachment system further includes a fourth pulley to redirect the strap extending out of the second pulley in a direction substantially horizontal to the ground surface, wherein the third pulley redirects the strap extending out of the fourth pulley in a direction toward the ground surface.

The overhead subject lift system according to any of the preceding clauses, wherein a third distance is defined between the exit of the overhead lift and a corresponding location on the ground surface, wherein a fourth distance is defined between the fourth pulley and a corresponding location on the ground surface, and wherein the fourth distance is greater than the second distance.

The overhead subject lift system according to any of the preceding clauses, wherein the ground surface is substantially planar.

The overhead subject lift system according to any of the preceding clauses, wherein the track extends along an overhead surface that is substantially planar.

The overhead subject lift system according to any of the preceding clauses, wherein the power source includes a rechargeable battery.

The overhead subject lift system according to any of the preceding clauses, wherein the power source includes an electrical plug for coupling to a remote power source.

The overhead subject lift system according to any of the preceding clauses, wherein the trolley attachment system further includes one or more redirecting features for removably coupling the trolley attachment system to the track.

The overhead subject lift system according to any of the preceding clauses, wherein the one or more redirecting features includes a wheel.

The overhead subject lift system according to any of the preceding clauses, wherein the body of the trolley attachment system includes a first portion and a second portion, and wherein a resilient member couples the first portion to the second portion such that the first portion can move relative to the second portion.

The overhead subject lift system according to any of the preceding clauses, wherein the resilient member includes a spring.

The overhead subject lift system according to any of the preceding clauses, wherein the track defines a channel therein, and wherein the channel is sized to slidably receive at least a portion of the trolley redirecting feature therein.

The overhead subject lift system according to any of the preceding clauses, wherein the trolley attachment system further includes one or more bumpers extending from the body toward the track when the trolley attachment system is coupled to the track.

The overhead subject lift system according to any of the preceding clauses, wherein the one or more bumpers include a first bumper portion positioned on a first side of the track and a second bumper portion positioned on a second side of the track.

The overhead subject lift system according to any of the preceding clauses, wherein the one or more bumpers include a wheel.

The overhead subject lift system according to any of the preceding clauses, wherein the overhead surface is defined on a ceiling.

The overhead subject lift system according to any of the preceding clauses, wherein the overhead surface is defined on a freestanding structure.

The overhead subject lift system according to any of the preceding clauses, wherein the freestanding structure is collapsible.

The overhead subject lift system according to any of the preceding clauses, wherein the freestanding structure includes one or more support columns, and wherein the overhead surface extends between the one or more support columns.

The overhead subject lift system according to any of the preceding clauses, wherein a height of the one or more support columns is selectively adjustable.

The overhead subject lift system according to any of the preceding clauses, wherein the body includes one or more support trusses coupled thereto.

The overhead subject lift system according to any of the preceding clauses, wherein the one or more support trusses are welded to the body.

The overhead subject lift system according to any of the preceding clauses, wherein the one or more support trusses are screwed to the body.

An overhead subject lift system is disclosed. The overhead subject lift system includes a track defined on an overhead surface, an overhead lift including a housing and a strap extending out of the housing at an exit toward a ground surface, wherein the exit is located a first distance from the overhead surface, and a trolley attachment system slidably engaged with the track. The trolley attachment system includes a body, wherein the overhead lift is removably coupled to the body and redirecting members to redirect the strap extending out of the housing of the overhead lift at the exit toward a second point, wherein the second point extends a second distance from the overhead surface, and wherein the first distance is greater than the second distance.

The overhead subject lift system according to any of the preceding clauses, wherein the redirecting members include a first pulley to redirect the strap extending out of the housing of the overhead lift at the exit toward the track and a second pulley to redirect the strap extending out of the first pulley toward the ground surface at the second point.

A subject lift system is disclosed, the subject lift system including an overhead lift and a trolley attachment system. The overhead lift is configured to engage a track. The overhead lift includes a housing and a strap extending out of the housing. The housing has an upper surface and a lower surface positioned opposite the upper surface. The strap extends out of the housing at the exit defined on the lower surface, wherein the strap is configured to support the weight of a subject. The trolley attachment system includes a body and a guide configured to redirect the strap extending out of the housing at the exit toward a second point which is closer to the track than the exit such that the strap turns upwardly from the exit and toward the track during use. The overhead lift is configured to couple to the body.

It will now be understood that the disclosure provides various solutions for maximizing the amount of vertical space between a ground surface and an overhead subject lift system. The described solutions provide improved trolley attachment systems having one or more redirecting members to redirect a buckle and a strap fed out of a motorized overhead lift. In various instances, the described solutions provide overhead subject lift systems having improved stability to combat torque and/or other forces applied thereto as a result of transporting a subject from one position to another position. Such solutions also allow for the trolley attachment systems to be selectively used in numerous locations and/or for numerous subjects, by being readily removable from an overhead track and/or by the overhead subject lift system being independently transportable, or otherwise freestanding, for example.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular aspects have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. An overhead subject lift system, comprising:
a track defined on or coupled to an overhead surface;
an overhead lift comprising:
a housing;
a motor; and
a strap extending out of the housing at an exit thereof toward a ground surface, the exit located a first distance from the overhead surface; and
a trolley attachment system slidably engaged with the track, the trolley attachment system comprising:
a body;
a first pulley to redirect the strap extending out of the housing of the overhead lift at the exit toward the track; and
a second pulley to redirect the strap extending out of the first pulley toward the ground surface, wherein the second pulley extends a second distance from the overhead surface, wherein the first distance is greater than the second distance.

2. The overhead subject lift system of claim 1, wherein a third distance is defined between the exit of the overhead lift and a first location on the ground surface positioned directly under the exit, wherein a fourth distance is defined between the second pulley and a second location on the ground surface positioned directly under the second pulley, and wherein the fourth distance is greater than the third distance.

3. The overhead subject lift system of claim 1, wherein the trolley attachment system further comprises one or more attachment features for removably coupling the trolley attachment system to the track.

4. The overhead subject lift system of claim 3, wherein the track defines a channel therein, and wherein the channel is sized to slidably receive at least a portion of the one or more attachment features therein.

5. The overhead subject lift system of claim 1, wherein the body of the trolley attachment system comprises a first portion and a second portion, and wherein a resilient member couples the first portion to the second portion such that the first portion moves relative to the second portion.

6. The overhead subject lift system of claim 1, wherein the trolley attachment system further comprises one or more bumpers extending from the body toward the track when the trolley attachment system is coupled to the track.

7. The overhead subject lift system of claim 6, wherein the one or more bumpers comprise:
a first bumper portion positioned adjacent a first side of the track; and
a second bumper portion positioned adjacent a second side of the track.

8. The overhead subject lift system of claim 6, wherein the one or more bumpers comprise a wheel.

9. A trolley attachment system for slidable engagement with a track defined on an overhead surface and removable attachment to an overhead lift having a strap extending away from the overhead surface at an exit thereof, the trolley attachment system comprising:
a body;
a first pulley extending from the body to redirect the strap extending out of the overhead lift at the exit toward the track, the exit located a first distance from the overhead surface; and
a second pulley extending from the body to redirect the strap extending out of the first pulley toward a ground surface, wherein the second pulley extends a second distance from the overhead surface, wherein the first distance is greater than the second distance.

10. The trolley attachment system of claim 9, further comprising a third pulley positioned in between the first pulley and the second pulley to redirect the strap extending out of the first pulley in a direction substantially horizontal to the ground surface, and wherein the second pulley redirects the strap extending out of the third pulley toward the ground surface.

11. The trolley attachment system of claim 9, wherein the trolley attachment system further comprises one or more attachment features for removably coupling the trolley attachment system to the track.

12. The trolley attachment system of claim 11, wherein the one or more attachment features comprises a wheel.

13. The trolley attachment system of claim 9, wherein the body of the trolley attachment system comprises a first portion and a second portion, and wherein a resilient member couples the first portion to the second portion such that the first portion moves relative to the second portion.

14. The trolley attachment system of claim 13, wherein the resilient member comprises a spring.

15. The trolley attachment system of claim 9, wherein the body of the trolley attachment system comprises a first portion and a second portion, and wherein an expanding member couples the first portion to the second portion such that the first portion is flexible relative to the second portion.

16. The trolley attachment system of claim 15, wherein the expanding member comprises a hinge.

17. The trolley attachment system of claim 16, wherein the hinge is in an open position when the trolley attachment system is coupled to a curved track.

18. A subject lift system, comprising:
an overhead lift configured to engage a track, the overhead lift comprising:
a housing having an upper surface and a lower surface positioned opposite the upper surface; and
a strap extending out of the housing at an exit defined on the lower surface, wherein the strap is configured to support a subject;
a trolley attachment system comprising:
a body, wherein the overhead lift is configured to couple to the body; and
a guide configured to redirect the strap extending out of the housing at the exit toward a second point which is closer to the track than the exit such that the strap turns upwardly from the exit and toward the track during use.

19. The subject lift system of claim 18, wherein the trolley attachment system further comprises one or more attachment features for removably coupling the trolley attachment system to the track.

20. The subject lift system of claim 19, wherein the track defines a channel therein, and wherein the channel is sized to slidably receive at least a portion of the one or more attachment features therein.
